(19) United States
(12) Patent Application Publication
(10) Pub. No.: US 2007/0151679 A1
(43) Pub. Date: Jul. 5, 2007

(54) Method of producing fibre products

(76) Inventors: Stina Gronqvist, Tolkkinen (FI); Eero Hurme, Espoo (FI); Maria Smolander, Espoo (FI); Anna Suurnakki, Espoo (FI); Liisa Vikari, Helsinki (FI)

Correspondence Address: SUGHRUE MION, PLLC, 2100 PENNSYLVANIA AVENUE, N.W., SUITE 800, WASHINGTON, DC, 20037, US

(21) Appl. No.: 10/583,711

(22) PCT Filed: Dec. 23, 2004
(86) PCT No.: PCT/FI04/00798

§ 371 Date: Oct. 2, 2006

(30) Foreign Application Priority Data
Dec. 23, 2003 (FI) 20031903

(51) Int. Cl. D21H 11/20; D21H 21/14; C08F 251/02

(52) U.S. Cl. 162/9; 162/157.6; 162/72

(57) ABSTRACT

A process for producing fibrous material, comprising a lignocellulosic material with phenolic or similar structural groups, and a signaling agent, said process comprising the steps of oxidizing phenolic or similar structural groups of the lignocellulosic matric to provide an oxidized fibre material, and directly, or via a tagging agent binding to the oxidized fibre material with a signaling agent which is capable of providing the lignocellulosic fibre material with properties foreign to the native fibre so that the fibres or products prepared therefrom can be detected. The signaling agent bonded to the fibres makes it possible to identify the product, trace it and to use it as a security/anti-counterfeit product.

### BACKGROUND OF THE INVENTION

1. Field of the Invention

The present invention relates to a method of producing fibre products having preselected properties. In particular, the present invention concerns a method according to the preamble of claim 1 of functionalizing wood fibres.

2. Description of Related Art

A known problem in the security of paper- and other related products has long been that, in addition to watermarks, not many methods have been available, with which this security could have been improved. Only during the last few years have these methods been studied more closely.

Known methods include technical solutions in which magnetic materials are utilized for product protection (Portals Ltd, U.S. Pat. No. 4,183,989), in which individual information is found in nano-barcodes (Nanoflex, U.S. Pat. No. 2003,209,427) and in which a colour changing identifier is used for authentication (Portals Ltd, U.S. Pat. No. 4,037,007).

In U.S. Pat. No. 4,183,989 a magnetic material as well as a luminescent material, an x-ray absorbent or a non-magnetic metal is used for increasing the security features of paper. The characteristics of papers manufactured in this way can be detected purely by machine-based techniques.

Published U.S. Patent Application No. 2003/209,427 discloses segmented nanoparticles, which are manufactured according to different methods, using different apparatuses. The template used for manufacturing the particles is chosen from the group consisting of Al₂O₃-membranes, photolithographically prepared templates, porous polycarbonate membranes, zeolites and block copolymers.

U.S. Pat. No. 4,037,007 concerns a method of improving the production of security documents. The security mechanisms that these documents contain have earlier been based mainly on watermarks and security threads. Said known patent teaches a paper, onto which an agent has been added that may take part in a colour forming reaction when another agent is added, which is needed to finish the reaction.

In U.S. Pat. No. 6,045,656, a method is described for producing anti-counterfeit paper using a fluorescent dye, which has been added to the papermaking fibres.

Published Patent Application No. U.S. 2004,209,052 describes a method used for adding luminescent synthetic polymer security dots into different products in order to prevent copying of the products.

Still, also these new techniques are hampered by various problems. In particular, as regards methods where the functionality is embedded into the fibres, these desired functionalities are not attached permanently in the fibre matrix, with covalent linkages. As a result, the signalling substances will detach from the fibres and from the fibrous products during production and during use.

### SUMMARY OF THE INVENTION

It is an aim of the present invention to remove at least some of the disadvantages of the prior art and achieve reliable attachment of functionalization compounds to target fibres. In particular, it is an aim to covalently or physically attach functionalization compounds to fibres used for production of paper- or other related products, thus giving these products increased security.

The present invention is based on the idea of carrying out a chemo-enzymatic functionalization of lignocellulosic fibres as a first step before contacting the fibres with signalling compounds which impart information to the fibres. The information is preferably of a kind which can be detected from the fibres after manufacture or from products produced from the fibres. Thus, based on the above, the invention comprises a method of producing fibrous products with modified properties by activating the fibres of the matrix with an oxidizing agent capable of oxidizing phenolic or similar structural groups, and attaching compounds to the activated fibre in order to incorporate desired, pre-selected properties of signalling into the fibre matrix. The activation is carried out either enzymatically or chemically, by mixing the fibres with an oxidizing agent.

A second alternative according to the invention includes the steps of
oxidizing phenolic or similar structural groups of the lignocellulosic matric to provide an oxidized fibre material, and
contacting the oxidized fibre material with a modifying agent containing at least one first functional group or portion, which is compatible with the oxidized fibre material, and at least one second functional group in order to provide a lignocellulosic fibre material having a modified surface.

According to the invention, fibres activated as described above are contacted with a signalling agent. The signalling agent has at least one functional site, which provides for binding of the signalling agent to the lignocellulosic fibre material, in particular at the oxidized phenolic groups or corresponding chemical structures of the fibres, which have been oxidized during the activation step. The “functional site” can be a functional group or a functional structure or portion, which is capable of binding the agent to the oxidized substrate. Altenatively, the signalling agent is contacted with the second functional site of the modifying agent bound to the oxidized phenolic groups. In that case, the “functional site” of the signalling agent is capable of binding to the second functional site of the modifying, typically bifunctional agent.

In order to introduce to the fibres novel properties, the agent has “signalling” properties as such or it is capable of developing such properties when it is attached to the fibres

More specifically, the present invention is mainly characterized by what is stated in the characterizing parts of claims 1 and 2.

Significant advantages are achieved with the present invention and, thus, the disadvantages of the prior art may be reduced or eliminated.

The unchangeable signalling agent or identifier in the paper, or other fibre product, makes it possible to identify the product, trace it, use it for anti-counterfeit or protect a brand. The applications of the products can be for example using them for identification and tracing of fibre materials for subsequent use as recycled and returnable paper as well as for fibre based products and valuable paper products. This way, new pre-determined features may be added to the products. These features can include, for example, a distinct colour, which can be added to the product, either straight after adding of the reagent, or at the detection stage, when the product is further modified.

Further advantages of the invention include the signalling agent or identifier being incorporated into the fibre material, not as a separate label or print. An identifier in the material itself is impossible to remove without destroying the product. It can also not be added to the product after the production of the material, which makes the use of duplicated labels difficult.

In other words, the invention may be used to further improve the safety features of paper products.

Among the advantages of functionalization is also that there is no need for a separate label or print after the functionalization. It is also difficult, if not impossible, to change, duplicate or add more information to the paper product after production. This prevents counterfeiters from reproducing packaging and endangering brand status and product revenue. With these products also other advantages are achieved, as reducing problems with recyclability and cost-effective reading systems

Next, the invention will be examined more closely with the aid of a detailed description and a number of working examples.

### DETAILED DESCRIPTION OF THE INVENTION

According to the method explained by the present invention, wood fibres are modified by functionalization. The invention is a special application of a technology, which is described in our copending Finnish patent application filed on 23 Dec. 2003 under number 20031903 for “Process for Producing a Fibrous Products”, the contents of which are herewith incorporated by reference.

Earlier it has been discovered that components containing new characteristics can be added to wooden fibres by chemo-enzymatic functionalization. It has now also become clear that this type of functionalization can be used to attach unchanged information to the wooden fibres. In this case, unchanged information means components that are later identifiable, e.g. when it becomes current to establish the origin of the product.

An unchangable identification in a paper or other fibre product makes it possible to establish the origin of the fibre product (e.g. in which plant the product has been manufactured). Using the identification, the authenticity can be proven and the identification also makes it more difficult to produce copies.

The applications of these fibre products can be used for example for special papers and boards, as well as the further processed products of these.

The fibre matrix comprises fibres containing phenolic or similar structural groups, which are capable of being oxidized by suitable oxidizing agents. Such fibres are typically “lignocellulosic” fibre materials, which include fibre made of annual or perennial plants or wooden raw material by, for example, mechanical, chemimechanical or chemical pulping. During industrial refining of wood by, e.g., refiner mechanical pulping (RMP), pressurized refiner mechanical pulping (PRMP), thermomechanical pulping (TMP), groundwood (GW) or pressurized groundwood (PGW) or chemithermomechanical pulping (CTMP), a woody raw material, derived from different wood species as for example hardwood and softwood species, is refined into fine fibres in processes, which separate the individual fibres from each other. The fibres are typically split between the lamellas along the interlamellar lignin layer, leaving a fibre surface, which is at least partly covered with lignin or lignin-compounds having a phenolic basic structure

Within the scope of the present invention, also chemical pulps are included if the concentration of lignin in the fibre matrix is at least 0.1 wt-%, preferably at least about 1.0 wt-%. In addition to paper- and paperboard-making pulps of the above kind, also other kinds of fibres of plant origin can be treated, such as bagasse, jute, flax and hemp.

In the first stage of the present process, the lignocellulosic fibre material is reacted with a substance capable of catalyzing the oxidation of phenolic or similar structural groups to provide an oxidized fibre material. Typically, the substance is an enzyme and the enzymatic reaction is carried out by contacting the lignocellulosic fibre material with an oxidizing agent, which is capable—in the presence of the enzyme—of oxidizing the phenolic or similar structural groups to provide an oxidized fibre material. Such oxidizing agents are selected from the group of oxygen and oxygen-containing gases, such as air, and hydrogen peroxide. Oxygen can be supplied by various means, such as efficient mixing, foaming, gases enriched with oxygen or oxygen supplied by enzymatic or chemical means, such as peroxides to the solution. Peroxides can be added or produced in situ.

According to an embodiment of the invention, the oxidative enzymes capable of catalyzing oxidation of phenolic groups, are selected from, e.g. the group of phenoloxidases (E.C.1.10.3.2 benzenediol:oxygen oxidoreductase) and catalyzing the oxidation of o- and p-substituted phenolic hydroxyl and amino/amine groups in monomeric and polymeric aromatic compounds. The oxidative reaction leads to the formation of phenoxy radicals. Another groups of enzymes comprise the peroxidases and other oxidases. “Peroxidases” are enzymes, which catalyze oxidative reaction using hydrogen peroxide as their electron acceptor, whereas “oxidases” are enzymes, which catalyze oxidative reactions using molecular oxygen as their electron acceptor.

In the method of the present invention, the enzyme used may be for example laccase, tyrosinase, peroxidase or oxidase, in particular, the enzyme is selected from the group of laccases (EC 1.10.3.2), catechol oxidases (EC 1.10.3.1), tyrosinases (EC 1.14.18.1), bilirubin oxidases (EC 1.3.3.5), horseradish peroxidase (EC 1.11.1.7), manganase peroxidase (EC1.11.1.13) and lignin peroxidase (EC 1.11.1.14).

The amount of the enzyme is selected depending on the activity of the individual enzyme and the desired effect on the fibre. Advantageously, the enzyme is employed in an amount of 0.0001 to 10 mg protein/g of dry matter fiber.

Different dosages can be used, but advantageously a dosage of about 1 to 100,000 nkat/g, more advantageously 10-500 nkat/g.

The activation treatment is carried out in a liquid medium, preferably in an aqueous medium, such as in water or an aqueous solution, at a temperature in the range of 5 to 100° C., typically about 10 to 85° C. Normally, a temperature of 20-80° C. is preferred. The consistency of the pulp is, generally, 0.5 to 95% by weight, typically about 1 to 50% by weight, in particular about 2 to 40% by weight. The pH of the medium is preferably slightly acidic, in particular the pH is about 2 to 10, in the case of phenoloxidases. Peroxidases are typically employed at pH of about 3 to 12. The reaction mixture is stirred during oxidation. Other enzymes can be used under similar conditions, preferably at pH 2-10. The fibres can be treated separately in an aqueous solution or on the formed web

According to another embodiment, the lignocellulosic fibre material is reacted with a chemical oxidizing agent capable of catalyzing the oxidation of phenolic or similar structural groups to provide an oxidized fibre material in the first stage of the process. The chemical oxidizing agent may be a typical, free radical forming substance such as hydrogen peroxide, Fenton reagent, organic peroxidase, potassium permanganate, ozone and chloride dioxide. Examples of suitable salts are inorganic transition metal salts, specifically salts of sulphuric acid, nitric acid and hydrochloric acid. Ferric chloride is an example of suitable salts. Strong chemical oxidants such as alkali metal- and ammonium persulphates and organic and in-organic peroxides can be used as oxidising agents in the first stage of the present process. According to an embodiment of the invention, the chemical oxidants capable of oxidation of phenolic groups are selected from the group of compounds reacting by radical mechanism.

According to another embodiment, the lignocellulosic fibre material is reacted with a radical forming radiation capable of catalyzing the oxidation of phenolic or similar structural groups to provide an oxidized fibre material. Radical forming radiation comprises gamma irradiation, electron beam radiation or any high energy radiation capable of forming radicals in a lignocellulose or lignin containing material.

Chemically the wood fibres can be activated by addition of radicalisation agents (e.g chemicals that cleave to form radicals). Normally, ambient temperature (+15 to +20° C.) or lowered temperature −10° C. to +15° C. are preferred, but temperatures of 5 to 100° C., typically about 10 to 85° C. or a slightly elevated temperature (20-80° C.) may be used.

In the second step of the process, a signaling agent is bonded to the oxidized phenolic or similar structural groups of the matrix. The signaling agent typically exhibits at least one first functional site, which is compatible with the fibrous matrix or with the tagging agent, and least one second functional site or structure providing for the above technical effect, as will be explained in more detail below.

The first functional site comprises in particular functional groups, which are capable of contacting and binding to the fibre at the oxidized phenolic or similar structural groups or at its vicinity. The bond formed between the oxidized phenolic or similar residue can be covalent or ionic or even based on hydrogen bonding. Typical functionalities of the first functional site include reactive groups, such as hydroxyl (including phenolic hydroxy groups), carboxy, anhydride, aldehyde, ketone, amino, amine, amide, imine, imidine and derivatives and salts thereof, to mention some examples. Also electronegative bonds, such as carbon-to-carbon double bonds, carbon-to-hetero atom (e.g. C═N, C═O) as well as oxo or azo -bridges can provide for bonding to the oxidized residues.

It is essential that the signalling agent is chemically or physically bonded to the fibre matrix to such an extent that at least an essential part of it cannot be removed. One criterion, which can be applied to test this feature, is washing in aqueous medium, because often the fibrous matrix will be processed in an aqueous environment, and it is important that it retains the new and valuable properties even after such processing. Thus, preferably, at least 10 mol-%, in particular at least 20 mol-%, and preferably at least 30 mol-%, of the modifying agent remains attached to the matrix after washing or leaching in an aqueous medium.

In the above alternative, the signalling agent is bonded directly to the oxidized phenolic structure (or similar structure) on the fibre.

However, as mentioned above, it is also possible first to bind a modifying agent, or “tagging agent”, to the oxidized phenolic or similar structure. Such a tag can comprise a bifunctional agent, which is a compound containing at least one first functional site or group and at least one second functional group. The first and second functional groups can be identical or different. Thus, the first and second functional groups can be any of, for example, typical chemical reactive groups, such as hydroxyl (including phenolic hydroxy groups), carboxy, anhydride, aldehyde, ketone, amino, amine, amide, imine, imidine and derivatives and salts thereof, to mention some examples. Also electronegative bonds, such as double bonds, oxo or azo bridges, can provide for bonding to the oxidized residues. Any group capable of achieving a bond to a functional agent is included. The bond can be based on ionic or covalent bonding or hydrogen bonding. The modifying agent can comprise a plurality of second functional groups.

In the modifying agent, the first and second functional sites are attached to a hydrocarbon residue, which can be a linear or branched aliphatic, cycloaliphatic, heteroaliphatic, aromatic or heteroaromatic. According to one preferred embodiment, aromatic compounds having 1 to 3 aromatic ring(s)—optionally forming a fused cyclic structure—are used. As a typical example, aminophenol can be mentioned, which contains a first functionality compatible with the oxidized phenolic or similar structure (the phenolic hydroxyl group) and a second functionality compatible with the functional groups of the signalling agent.

As a typical example of the above bifunctional modifying agents, aminophenol can be mentioned, which contains a first functionality compatible with the oxidized phenolic structure (the phenolic hydroxyl group) and a second functionality, the amino group. Such a group is compatible, for example, with the functional groups of a signalling agent.

The interaction of the oxidized lignocellulosic material, or the lignocellulosic material+modifying agent, and the signaling agent, resulting in bonding of the signaling agent to the lignocellulosic material, typically takes place in liquid phase, usually in water or in another aqueous medium. The pulp or other lignocellulosic fibrous matrix is suspended in the medium and it is contacted with the modifying agent or a precursor thereof, which is dissolved or dispersed in the same medium. The conditions can vary freely, although it is preferred to carry out the contacting under mixing or stirring. The temperature is generally between the melting point and the boiling point of the medium; preferably it is about 5 to 100° C. Depending on the modifying agent or its precursor, the pH of the medium can be neutral or weakly alkaline or acidic (pH typically about 2 to 12). It is preferred to avoid strongly alkaline or acidic conditions because they can cause hydrolyzation of the fibrous matrix. Normal pressure (ambient pressure) is also preferred, although it is possible to carry out the process under reduced or elevated pressure in pressure resistant equipment. Generally, the consistency of the fibrous material is about 0.5 to 95% by weight during the contacting stage.

According to a particularly preferred embodiment, the first and the second stages of the process are carried out in the same reaction medium, without separating the fibrous matrix after the oxidation step. The conditions (consistency, temperature, pH, pressure) can, though, even in this embodiment be different during the various processing stages.

The first and the second stages of the process are carried out sequentially or simultaneously Also other compounds, such as papermaking chemicals may be present during the reaction steps.

Many possible types of compounds (signalling agents) can be introduced in the fibres. Specific structures can for example be added to or onto the fibres, making the detection very specific, or molecules, as antibodies, can be immobilized onto the surface of the fibres, achieving stable and oriented surfaces. The detection of small molecules can be achieved for example by using antibodies, making the compounds either visible or fluorescing

“Signalling agent” stands for any compound capable of attaching to the fibres information of predetermined kind, which can be detected from the fibres or product manufactured from the fibres at a later stage, for instance during use of the product.

Functionalization is used e.g. for recycled and returnable paper and fibre based products when adding traceability- and identification features to these. Also valuable paper products are functionalized, in order to prevent counterfeits and protect brands.

Based on the above, the introduced signalling agents can be divided into security components (e.g. fluorescent compounds which can be verified under UV light from scanners), metallic particles or chemical security features and machine-readable pigments.

The introduced compound comprises as such, or contains parts that are formed by:
thermochromes (colours that change upon changes in temperature)
photochromes (colours that change upon exposure to light)
conducting (polymers)
radioactive
fluorescent
luminescent
inorganic (e.g. nitrogen)

The signalling agents may contain one or several of the features above. The finished material can be modified throughout or the modification can be found in certain sites, e.g. as a stripe on the edge of the paper, or an area or a layer on the paper. The signalling agent may be directly detectable or detectable after a certain modification reaction. For example tags can be added in the detection stage to further clearly enhance the attachment of a polymer.

The signalling agent can be chosen e.g. among following compunds:

Acid Green 41

Alizarin Red S

Alizarin Yellow GG

Bromocresol Purple

Celestine Blue

o-cresolphtalein

Cresol Red

Fluorescein

Gallocyanine

Hematoxylin

4-methylesculetin

9-phenyl-2,3,7-trihydroxy-6-fluorone

Plasmocorinth B

Purpurin

Quinalizarin

Thymolphtalein

Tiron

Xylenol Blue

Xylenol Orange

The detection methods for the compounds can be divided into detection made by visual colour change, laser, magnetics, conductivity, microwaves, ultrasonic, infrared, mass spectrometry, gas chromatography, physical agents and combinations thereof. In other words, the detection can be based on a change in colour (e.g. a central layer that is torn out for detection and contains an agent that changes its colour when exposed to heat or moisture or light), radioactivity, chemistry, radiation, smell, conductivity or ultrasound.

After the above processing, the modified fibre having new properties is generally separated from the liquid reaction and further used in target applications.

In summary, the present invention provides a process for producing a fibrous material, comprising a lignocellulosic material with phenolic or similar structural groups, and a signalling agent, said process comprising the steps of oxidizing phenolic or similar structural groups of the lignocellulosic matric to provide an oxidized fibre material, and directly, or via a tagging agent binding to the oxidized fibre material with a signalling agent which is capable of providing the lignocellulosic fibre material with properties foreign to the native fibre so that the fibres or products prepared therefrom can be detected. The signalling agent bonded to the fibres makes it possible to identify the product, trace it, and to use it as a security/anti-counterfeit product.

The following non-limiting example illustrates the invention:

### EXAMPLE 1

Bonding of Ferulic Acid

A 5 g portion of spruce TMP was suspended in water. The pH of the suspension was adjusted to pH 4.5 by addition of acid. Laccase dosage was 500 nkat/g of pulp dry matter and the final pulp consistency was 7.5%. After 15 minutes laccase reaction the new compound was added to the pulp suspension. After 90 min total reaction time, the pulp suspension was filtered and the pulp was washed thoroughly with water. Handsheets were prepared. For comparison purposes, reference treatments were carried out using the same procedure as described above but without addition of laccase or the new compound.

The bonded ferulic acid was detected by conductometric titration.

TABLE 1

| | Total amount of |
|---|---|
| | acidic groups |
| Treatment | (μmol/g) |
| TMP Reference | 89 |
| TMP + laccase + ferulic acid (0.15 mmol/g) | 135 |

### EXAMPLE 2

Bonding of L-Dopa

A 5 g portion of spruce TMP was suspended in water. The pH of the suspension was adjusted to pH 4.5 by addition of acid. Laccase dosage was 1000 nkat/g of pulp dry matter and the final pulp consistency was 7.5%. After 30 minutes laccase reaction the new compound was added to the pulp suspension. After 1 h min total reaction time at RT, the pulp suspension was filtered and the pulp was washed thoroughly with water. The nitrogen content of the treated pulp was analysed with a CHN-600 analysator.

TABLE 2

| Treatment | Nitrogen content (%) |
|---|---|
| TMP Reference | 0.06 |
| TMP + laccase + L-Dopa | 0.25 |

### EXAMPLE 3

A Radioactive Compound as a Signalling Agent

A 2 g portion of spruce TMP was suspended in water. The pH of the suspension was adjusted to pH 4.5 by addition of acid. Laccase dosage was 1000 nkat/g of pulp dry matter and the final pulp consistency was 7.5%. After 30 minutes laccase reaction 7,8-³H Dopamine was added to the pulp suspension. After 60 min total reaction time, the pulp suspension was filtered and the pulp was washed thoroughly with water. For comparison purposes, reference treatments were carried out using the same procedure as described above but without addition of laccase or the new compound. The 7,8-³H Dopamine could be detected from the pulp after the treatment by measuring the radioactivity of the sample.

### EXAMPLE 4

A pH-Indicator Compound as Signalling Agent

A 5 g portion of spruce TMP was suspended in water. The pH of the suspension was adjusted to pH 4.5 by addition of acid. Laccase dosage was 1000 nkat/g of pulp dry matter and the final pulp consistency was 7.5%. After 30 minutes laccase reaction Bromcresol Purple was added to the pulp suspension. After 1 h min total reaction time at RT, the pulp suspension was filtered and the pulp was washed thoroughly with water. The presence of the compound in the pulp was detected visually by contacting with aqueous solutions with different pH values.

### EXAMPLE 5

A Fluorescent Compound as Signalling Agent

A 5 g portion of spruce TMP was suspended in water. The pH of the suspension was adjusted to pH 4.5 by addition of acid. Laccase dosage was 1000 nkat/g of pulp dry matter and the final pulp consistency was 7.5%. After 30 minutes laccase reaction Plasmocorinth B was added to the pulp suspension. After 1 h min total reaction time at RT, the pulp suspension was filtered and the pulp was washed thoroughly with water. The compound was detected from the pulp by analysing the fluorescence of the treated pulp.

### EXAMPLE 6

A Colorimetric Reagent as Signalling Agent

A 5 g portion of spruce TMP was suspended in water. The pH of the suspension was adjusted to pH 4.5 by addition of acid. Laccase dosage was 1000 nkat/g of pulp dry matter and the final pulp consistency was 7.5%. After 30 minutes laccase reaction Tiron was added to the pulp suspension. After 1 h min total reaction time at RT, the pulp suspension was filtered and the pulp was washed thoroughly with water. The compound was detected colorimetrically from the pulp in the presence of iron (III).

### EXAMPLE 7

Chemical Bonding of a Luminescent Compound.

Dodecyl gallate was chemically modified to contain a luminescent part. The modified dodecyl-gallate was bonded chemically to CTMP.

A chemical treatment was started by mixing 20 g TMP in a mixer at a consistency of 15% for 10 minutes at RT. APS dissolved in water was added (0.075g/g of pulp dry matter) during this time. An aqueous solution of the modified dodecyl gallate was added (equivalent to 0.6 mmol dodecyl gallate/g pulp) and the pulp was mixed for 2 h. After all addition of the pulp consistency was 8%. The compound was detected from the pulp by analysing the luminescence of the treated pulp.

### EXAMPLE 8

Chemical Bonding of a Fluorescent Compound.

A chemical treatment was started by mixing 20 g TMP in a mixer at a consistency of 15% for 10 minutes at RT. APS dissolved in water was added (0.075 g/g of pulp dry matter) during this time. An aqueous solution of sodium salt of Xylenol Orange was added (equivalent to 0.6 mmol dye/g pulp) and the pulp was mixed for 2 h. After all addition of the pulp consistency was 8%. The compound was detected from the pulp by analysing the fluorescence of the treated pulp.

### EXAMPLE 9

Production of Conductive Fibre/Paper

A chemo-enzymatic treatment was started by mixing 20 g of cold-disintegrated TMP (pH ˜4.5) in a mixer at a consistency of 16% for 10 minutes at room temperature. Laccase (1000 nkat/g of pulp dry matter) was added as an aerosol during this time. After 30 min reaction an aqueous solution of 4-aminophenol, comprising 1.3 g aminophenol, 72 ml water and 8 ml 1 M HCl, was added. The added amount of 4-aminophenol was equivalent to 0.6 mmol 4-aminophenol/g pulp. After the addition, the pulp was mixed for 2 h at a pulp consistency of 10 wt-%.

Throughout the following steps, the suspension was stirred with a blade mixer:

290 ml of an aniline solution (containing 2 g of aniline and 17.2 g of DBSA) was added to the pulp suspension and 4.6 g of APS dissolved in water was added within 4 h. The pulp concentration was 3% after all additions. The pulp was additionally mixed for 12 h, thereafter the pulp was diluted to 2000 ml, filtrated twice, and washed with 400 ml of water.

After the treatments, handsheets were prepared from the pulps according to SCAN M5:76 on wire cloth. The handsheets were dried at room temperature. The surface resistencity (conductivity) of the handsheets was measured by using Premix SRM-110 and it was 10 exp 5 ohm/m². The nitrogen content of the samples was analysed by the Kjeldahl method, and N(1) was 1600 ppm and N(2) 1400 ppm.

1. A process for producing a fibrous material, comprising a lignocellulosic material with phenolic or similar structural groups, and a signalling agent, said process comprising the steps of
oxidizing phenolic or similar structural groups of the lignocellulosic matric to provide an oxidized fibre material, and
contacting the oxidized fibre material with a signalling agent containing at least one first functional group or portion, which is compatible with the oxidized fibre material, said signalling agent being capable of providing the lignocellulosic fibre material with properties foreign to the native fibre.

2. A process for producing a fibrous material, comprising a lignocellulosic material with phenolic or similar structural groups, and a signalling agent, said process comprising the steps of
oxidizing phenolic or similar structural groups of the lignocellulosic matric to provide an oxidized fibre material, and
contacting the oxidized fibre material with a modifying agent containing at least one first functional group or portion, which is compatible with the oxidized fibre material, and at least one second functional group in order to provide a lignocellulosic fibre material having a modified surface,
contacting the thus modified lignocellulosic fibre material with a signalling agent, and
bonding the signalling to the modified surface of the fibre material in order to impart to the fibre material new functional properties derivable from the signalling agent.

3. The process according to claim 1, wherein the lignocellulosic fibrous matrix is reacted with an oxidizing agent in the presence of a substance capable of catalyzing the oxidation of phenolic or similar structural groups by said oxidizing agent.

4. The process according to claim 1, wherein the signalling agent is activated with an oxidizing agent.

5. The process according to claim 1, wherein the signalling agents are selected from the group comprising security components, such as fluorescent compounds verifiable under UV light from scanners, metallic particles or chemical security features and machine-readable pigments.

6. The process according to claim 5, wherein the signalling agents is selected from the group of thermochromes, photochromes, electrically conductive substances, including electrically conductive polymers, radioactive compounds, fluorescent compounds, luminescent compounds and various inorganic compounds.

7. The process according to claim 1, wherein the signalling agent exhibits at least one functional site, which is compatible with the fibrous matrix or with the modifying agent in order to achieve covalent or physical bonding of the signaling agent to the lignocellulosic material.

8. The process according to claim 7, wherein the functional site comprises reactive groups selected from hydroxy, carboxy, anhydride, aldehyde, ketone, amino, amine, amide, imine, imidine and derivatives and salts thereof.

9. The process according to claim 1, wherein the signalling agent can be detected by visual colour change, laser, magnetics, conductivity, microwaves, ultrasonic, infrared, mass spectrometry, gas chromatography, physical agents, or combinations thereof.

10. The process according to claim 1, wherein the modifying compound is a bifunctional compound containing at least one first functional portion or group and at least one second functional group, the second functional group being selected from the group of hydroxyl (including phenolic hydroxy groups), carboxy, anhydride, aldehyde, ketone, amino, amine, amide, imine, imidine and derivatives and salts thereof.

11. The process according to claim 1, wherein the modifying compound is a bifunctional compound containing at least one first functional portion or group and at least one second functional group, the first functional group being selected from the group of hydroxy, carboxy, anhydride, aldehyde, ketone, amino, amine, amide, imine, imidine and derivatives and salts thereof.

12. The process according to claim 1, wherein the substance capable of catalyzing the oxidation of phenolic or similar structural groups is an enzyme or a chemical agent or a radiation agent.

13. The process according to claim 12, wherein the enzyme capable of catalyzing the oxidation of phenolic or similar structural groups is selected from the group of peroxidases and oxidases.

14. The process according to claim 13, wherein the enzyme is selected the group of laccases (EC 1.10.3.2), catechol oxidases (EC 1.10.3.1), tyrosinases (EC 1.14.18.1), bilirubin oxidases (EC 1.3.3.5), horseradish peroxidase (EC 1.11.1.7), manganase peroxidase (EC 1.11.1.13) and lignin peroxidase (EC 1.11.1.14).

15. The process according to claim 1, wherein the enzyme dosage is about 1 to 100,000 nkat/g, preferably 10-500 nkat/g, and it is employed in an amount of 0.0001 to 10 mg protein/g of dry matter.

16. The process according to claim 12, wherein the chemical agent is selected from the group of per-compounds, in particular from the group consisting of alkali metal persulphates and hydrogen peroxide.

17. The process according to claim 1, wherein the oxidizing agent is selected from the group of oxygen, hydrogen peroxide and oxygen-containing gases, such as air.

18. The process according to claim 1, wherein oxygen or oxygen-containing gas is introduced into the aqueous slurry during the reaction.

19. The process according to claim 1, wherein the reaction of step (a) is carried out in an aqueous or dry phase at a consistency of 1 to 95% by weight, preferably about 2 to 40% by weight, of the fibre material.

20. The process according to claim 1, wherein the reaction is carried out at a temperature in the range of from 5 to 100° C.
